(19) United States
(12) Patent Application Publication
(10) Pub. No.: US 2010/0254034 A1
(43) Pub. Date: Oct. 7, 2010

(54) AUTOMATIC ADJUSTMENT DEVICE FOR AUTOMOBILE SIDEVIEW MIRROR

(76) Inventor: PEI-CHENG CHIU, Kaohsiung City (TW)

Correspondence Address: LEONG C LEI, PMB # 1008, 1867 YGNACIO VALLEY ROAD, WALNUT CREEK, CA, 94598, US

(21) Appl. No.: 12/416,166

(22) Filed: Apr. 1, 2009

(51) Int. Cl. B60R 1/072

(52) U.S. Cl. 359/843

(57) ABSTRACT

An automobile adjustment device is provided for a sideview mirror of an automobile. The automatic adjustment device includes at least one main controller and a sensor element. The sensor element includes a microprocessor and is connected to a signal source of shift stick reverse position and signal sources of turn signal lights and is also connected to a drive unit of the sideview mirror. The sensor element is connected to the main controller to detect and transmit a parameter representing an angular position of the sideview mirror to the microprocessor of the main controller with which the microprocessor makes judgment.

### TECHNICAL FIELD OF THE INVENTION

The present invention generally relates to an automatic adjustment device for an automobile sideview mirror, and particularly to a device that automatically adjusts the angle of reflection of a sideview mirror during backing or turning of an automobile.

### DESCRIPTION OF THE PRIOR ART

Driver-side and passenger-side sideview mirrors play a very important role in car driving, for a regular person may see an angular range in the horizontal of about 200 degrees by simply turning his or her eyeballs without turning his or her head. In other words, there is an angular range of about 160 degrees in the horizontal that is not visible to the person. In this situation, the sideview mirrors help an automobile driver to check road conditions behind the automobile and other automobiles on the left and right hand sides of the automobile.

Adjusting the orientation of an automobile sideview mirror is often done with the operations of two motors, which respectively change the elevational angle and horizontal angle of the mirror surface. During the course of operating an automobile, a driver needs to move the automobile in both the forward direction and the backward direction, both requiring the sideview mirror to be set at different angles of reflection. In driving an automobile forward, a driver often sets the sideview mirror at such a position as to substantially correspond to the height of regular automobiles, whereby the driver may watch outside conditions on the left and/or right hand sides of the automobile in order to prevent collision with automobiles that are approaching from the back in changing lanes. However, to back the automobile for parking, it is often necessary to adjust the sideview mirror in such a way that the reflection surface of the mirror is set downward inclined to help observing the rear wheels of the automobile so that undesired bumping into a wall or construction along a road or crushing over the curbstones of a sidewalk or trapping into an uncovered gutter can be avoided.

Some top-class cars available in the market are already equipped with automatic mirror adjustment device. As shown in FIG. 1, a known electric sideview mirror 1 is adjustable of the angle of reflection by employing a servo device 11 to drive the adjustment operation of a mirror panel 12. The servo device 11 is comprised of two direct-current (DC) motors 13, 14 that are rotatable in opposite directions. By properly setting the two DC motors 13, 14, when a car is set in operation as being driven to move, the mirror panel 12 of the sideview mirror 1 is driven by the DC motors 13, 14 to realize angular movement in both vertical and horizontal direction in accordance with the driving condition of the automobile, such as turning and backing. Once the automobile resumes normal directly-forward movement, the mirror panel 12 of the sideview mirror 1 is once again driven by the DC motors 13, 14 to return to the original position. However, since each driver has his or her own height and each driver has his or her own behavior in driving a car, the factory-set rotation angle of the sideview mirror does not suit for every driver. Further, when the shift stick is put to the reverse position (R-position) for backing a car, the mirror panels 12 of both sideview mirrors 1 are automatically rotated downward to allow the driver to see the positions of the rear wheels. It is, however, noted that to make parallel parking alongside a road in a space between two cars in front of and behind the space, or to move the car out of the parking space, due to the cars or other obstacles in front of and behind the parking space, the driver must repeatedly move the car forward and backward for several times before the driver can finally park the car or move the car out of the parking space. The mirror panel 12 of the conventional sideview mirror 1 is operated in accordance with the turns of rotation of the DC motors 13, 14. Thus, when a car has been set in operation for a long period of time and has been repeatedly moved forward and backward many times, the DC motors 13, 14 may accumulate a large operation tolerance due to the repeated forward and backward movement of the mirror panel 12 of the sideview mirror 1. Once the tolerance is accumulated to quite an extent, the rotation of the mirror panel 12 of the sideview mirror deteriorates and cannot be set to the desired, pre-set position. An apparent error of shifting the view angle of the driver by the mirror panel 12 of the side view mirror 1 occurs consequently, causing the mirror to lose the function thereof. In addition, when a car is making a turn, the mirror panel 12 of the side view mirror 1 also rotates with the turning of the car body. Once again, with multiple times of turning of the car, the repeated forward/backward rotation of the mirror panel 12 of the sideview mirror 1 causes the DC motors 13, 14 to accumulate excessive tolerance, leading to incorrect positioning of the rotation of the mirror panel 12 of the sideview mirror 1 and eventually making the mirror losing function.

In view of the above discussed problems of the known sideview mirror, it is desired to provide a sideview mirror that is precisely positionable by following the movement of a car. This is one of the major challenges of the automobile industry.

### SUMMARY OF THE INVENTION

The technical solution of the present invention is to provide an automatic adjustment device for an automobile sideview mirror, wherein the automatic adjustment device comprises at least one main controller and a sensor element. The main controller comprises a microprocessor and is connected to signal sources of a shift stick reverse position and turn signals, and is also connected to a drive unit of a sideview mirror. The sensor element is connected to the main controller and provides a parameter of angular position of the sideview mirror to the microprocessor of the main controller with which the microprocessor makes judgment.

A primary objective of the present invention is that when the shift stick is put to the reverse position for backing a car, the main controller receives a signal of car backing and responsively generates an output signal to the drive unit of the sideview mirror, making the drive unit rotating the sideview mirror downward to a predetermined angular position to allow the driver of the car to see an enlarged range of space on the rear side of the car through the sideview mirror. When the backing signal ends, the drive unit automatically drives the sideview mirror in an opposite direction to rotate the sideview mirror upward back to the original position. As such, optimum use of the sideview mirror by a driver in backing a car can be realized to improve driving safety for car backing.

Another objective of the present invention is that when a car is about to make a turn and one of the turn signal lights is actuated, the main controller receives a signal from the turn signal light and responsively generates an output signal to the drive unit of the sideview mirror corresponding to the actuated turn signal light, making the drive unit driving the sideview mirror in such a way that the sideview mirror is rotated forward with respect to the car to a predetermined angular position to allow the driver of the car to see an enlarged range of space on the rear side of the car through the sideview mirror. When the turn signal ends, the drive unit automatically drives the sideview mirror in an opposite direction to rotate the sideview mirror backward with respect to the car to return back to the original position. As such, optimum use of the sideview mirror by a driver in turning a car can be realized to improve driving safety for car turning.

The foregoing objective and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective view illustrating a conventional automatic adjustment device for an automobile sideview mirror.

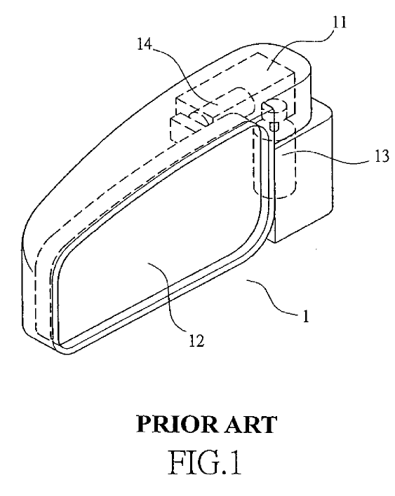

FIG. 2 is a perspective view showing an automobile in which the present invention is embodied.

FIG. 3 is a block diagram of an automatic adjustment for an automobile sideview mirror in accordance with the present invention.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

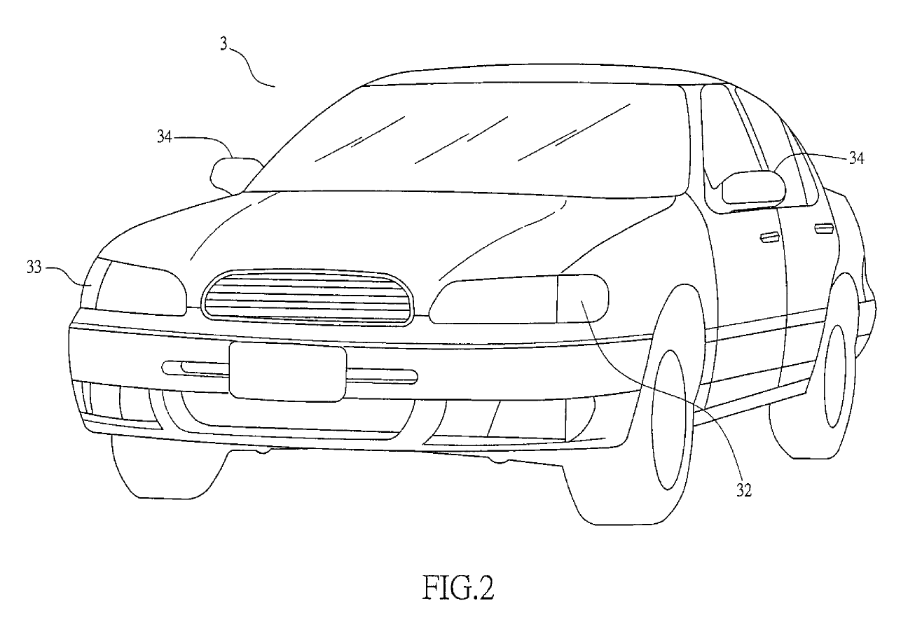

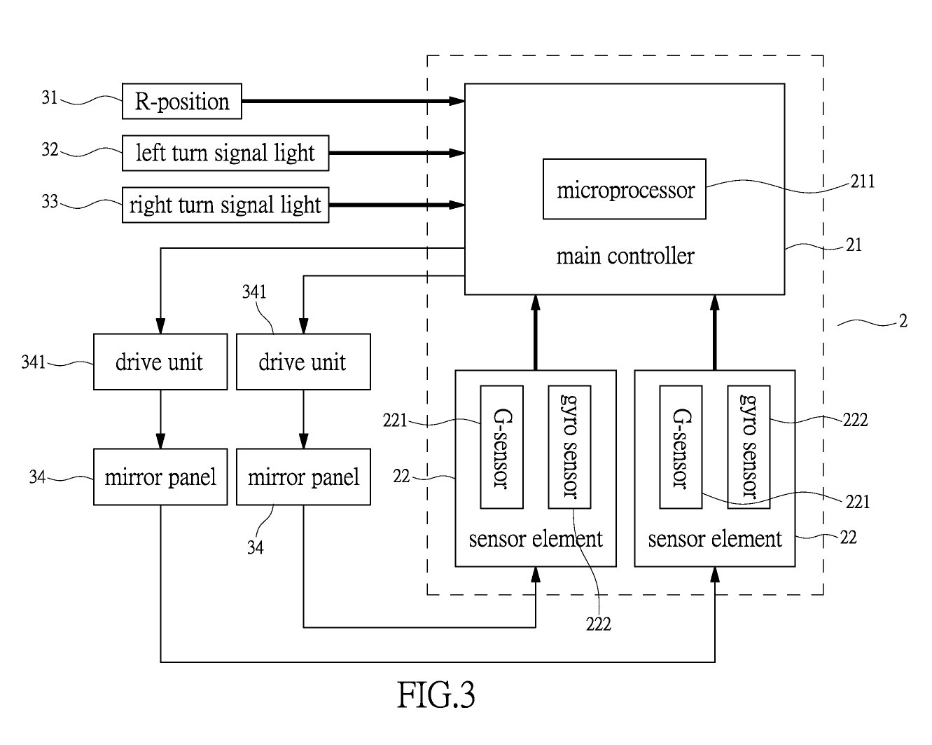

With reference to the drawings and in particular to FIGS. 2 and 3, an automatic adjustment device constructed in accordance with the present invention is provided for a sideview mirror of an automobile. The automatic adjustment device, which is generally designated at 2, comprises at least one main controller 21 and a sensor element 22. The main controller 21 comprises a microprocessor 211. The main controller 21 is installed in an automobile and is connected to a signal source of a shift stick reverse position (R-position) 31 and signal sources of left turn signal light 32 and right turn signal light 33. Further, the main controller 21 is also connected to a drive unit 341 of a mirror panel 34 of each sideview mirror of the automobile 3.

The sensor element 22 is connected to the main controller 21. In an embodiment, the main controller 21 comprises a G-sensor 221 and a gyro sensor 222, or any one of them. The sensor element 22 is mounted to a back side of the sideview mirror panel 34 and is movable with the mirror panel 34 for detecting a parameter representing an angular position of the mirror panel 34, which is transmitted to the microprocessor 211 of the main controller 21 with which the microprocessor 211 makes judgment.

In accordance with an embodiment of the present invention, the microprocessor 211 of the main controller 21 may identify the angular position parameter of the sideview mirror panel 34 in conditions of being still, vertically rotated upward/downward, and horizontally rotated forward/rearward. The angular position parameter of the mirror panel 34 can be pre-set in the microprocessor 211, or can be alternatively acquired through a training process of electronic equipment, and can be updated and modified as desired at any time. However, the pre-setting, training, and modification of the angular position parameter of the mirror panel 34 are readily achievable through electrical circuit design, together with proper operation, and are not considered novel part of the present invention. Details in these respects will not be further discussed.

When the automobile 3 is to be backed and the shift stick is set in the reverse position 31, the main controller 21 receives a signal from the reverse position 31 of the automobile 3 and generates a corresponding output signal to cause the drive unit 341 to drive at least one mirror panel 34 of the sideview mirrors of the automobile 3 so that the mirror panel 34 is rotated downward. With the rotation of the mirror panel 34, the G-sensor 221 and the gyro sensor 222 that are mounted to the back side of the mirror panel 34 rotate in unison with the mirror panel 34, leading to change of the angular position of the G-sensor 221 and the gyro sensor 222. Such a change continues until the angular position of the G-sensor 221 and the gyro sensor 222 reaches a preset parameter value, meaning the mirror panel 34 has been rotated to a predetermined position. The microprocessor 211 of the main controller 21, upon detecting the rotation of the G-sensor 221 and the gyro sensor 222 has reaches the preset angular position, immediately issues a signal to make the drive unit 341 stopping further driving the movement of the mirror panel 34. This completes the downward rotation operation of the mirror panel 34. The preset angular position to which the mirror panel 34 is rotated can be selected in advance to ensure that the mirror panel 34, once set at the predetermined position, can clearly show a lower position below the automobile 3 at the rear side thereof or even show a position around the rear wheel of the automobile 3 or a location adjacent thereto, whereby visual observation can be made by the driver in backing the automobile and accident occurring in backing the automobile can be avoided to effectively ensure driving safety. On the other hand, when the shift stick is moved to get out of the reverse position 31, the main controller 21 receives a corresponding signal and responsively generates an output signal to cause the drive unit 341 to drive the mirror panel 34 in a reverse direction. Once being driven in the opposite or reverse direction by the drive unit 341, the mirror panel 34 starts to rotate in an opposite direction, namely upward. With the upward rotation of the mirror panel 34, the G-sensor 221 and the gyro sensor 222 that are mounted to the back side of the mirror panel 34 rotate in unison therewith, again leading to change of the angular position of the G-sensor 221 and the gyro sensor 222. Such a change continues until the angular position of the G-sensor 221 and the gyro sensor 222 reaches a preset parameter value, namely the mirror panel 34 has been rotated upward to a predetermined position, which is the original position of the mirror panel 34 before the mirror panel 34 is subjected to downward rotation. At this time, the microprocessor 211 of the main controller 21, upon detecting the rotation of the G-sensor 221 and the gyro sensor 222 has reaches the preset angular position, immediately issues a signal to make the drive unit 341 stopping further driving the movement of the mirror panel 34 in the reverse direction. This completes the upward rotation operation of the mirror panel 34, making the mirror panel 34 reliably returned to the original position before the previous downward rotation was carried out, in order to be used by the driver for normal forward driving of the automobile 3.

In another embodiment of the present invention, in case the automobile 3 is to make a turn and one of the left and right turn signal lights 32, 33 is actuated, the main controller 21 receives a signal indicating the actuation of the turn signal light. For a special condition where both the left and right turn signal lights are turned on for issuing a warning signal to approaching vehicle, the main controller 21 may make discretion to neglect the signal and take no action. Thus, when the main controller 21 determines the turn signal is actuated correctly, the main controller 21 generates a corresponding output signal to cause the drive unit 341 of the mirror panel 34 associated with the actuated one of the turn signal lights to output power for driving the mirror panel 34, which then starts to rotate forward with respect to the body of the automobile 3. With the rotation of the mirror panel 34, the G-sensor 221 and the gyro sensor 222 that are mounted to the back side of the mirror panel 34 rotate in unison with the mirror panel 34, leading to change of the angular position of the G-sensor 221 and the gyro sensor 222. Such a change continues until the angular position of the G-sensor 221 and the gyro sensor 222 reaches a preset parameter value, meaning the mirror panel 34 has been rotated to a predetermined position. At this time, the microprocessor 211 of the main controller 21, upon detecting the rotation of the G-sensor 221 and the gyro sensor 222 has reaches the preset angular position, immediately issues a signal to make the drive unit 341 stopping further driving the movement of the mirror panel 34. This completes the forward rotation operation of the mirror panel 34. The preset angular position to which the mirror panel 34 is rotated forward with respect to the automobile 3 can be selected in advance to ensure that the mirror panel 34, once set at the predetermined position, can clearly show a wider space range at the rear side of the automobile 3, whereby visual observation of a wider range behind the automobile can be made by the driver in turning the automobile to effectively ensure driving safety in making a turn. On the other hand, when the turning of the automobile 3 is completed and the signal output from the turn signal light is ended, the main controller 21 is signaled so and responsively generates an output signal to cause the drive unit 341 to drive the mirror panel 34 in a reverse direction, making the mirror panel 34 rotated rearward with respect to the automobile. With the rearward rotation of the mirror panel 34, the G-sensor 221 and the gyro sensor 222 that are mounted to the back side of the mirror panel 34 rotate in unison therewith, again leading to change of the angular position of the G-sensor 221 and the gyro sensor 222. Such a change continues until the angular position of the G-sensor 221 and the gyro sensor 222 reaches a preset parameter value, namely the mirror panel 34 has been rotated rearward to a predetermined position, which is the original position of the mirror panel 34 before the mirror panel 34 is subjected to forward rotation. At this time, the microprocessor 211 of the main controller 21, upon detecting the rotation of the G-sensor 221 and the gyro sensor 222 has reaches the preset angular position, immediately issues a signal to make the drive unit 341 stopping further driving the movement of the mirror panel 34 in the reverse direction. This completes the rearward rotation operation of the mirror panel 34, making the mirror panel 34 reliably returned to the original position before the previous forward rotation was carried out, in order to be used by the driver for normal forward driving of the automobile 3.

In a further embodiment of the present invention, when the automobile is about to make a turn and one of the left and right turn signal lights 32, 33 is actuated, besides what discussed above where the mirror panel 34 is driven by the drive unit 341 to rotate forward to a predetermined position, it is possible to provide a design wherein the mirror panel 34 is first rotated forward to the predetermined position and is then driven again by the drive unit 341 to carry out rearward rotation, preferably slowly, and afterwards, the mirror panel 34 is continuously and alternately driven forward and rearward in such a way that the mirror panel 34 repeatedly swags forward and rearward. This helps expanding the viewing angle of the driver.

It is to be noted that when the mirror panel 34 starts to rotate, whether the power output by the drive unit 341 is in a given forward direction or in an opposite direction, in case that due to any unexpected trouble or problem of the drive unit 341, the mirror panel 34 is over-driven or under-driven and the angular position of the G-sensor 221 and the gyro sensor 222 does not precisely reach the desired parameter value, the microprocessor 211 of the main controller 21 may detect such a situation and the microprocessor 211 may base on the parameter fed back to generate a further output signal that makes the drive unit 341 continuously operate in the desired direction for positional correction for the mirror panel 34, so that the mirror panel 34 may be eventually set at the desired, correct angular position.

This mechanism allows the mirror panel 34 to be precisely rotated to the predetermined goal position and incorrect rotation of the mirror panel 34 that leads to incorrect positioning of the mirror panel 34 occurring in the known techniques can be eliminated.

To conclude, the automatic adjustment device for automobile sideview mirror in accordance with the present invention is effective in solving the drawback of error accumulation caused by repeated adjustment of mirror panel of the sideview mirror and can ensure automobile operability and driving safety.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. An automatic adjustment device for an automobile sideview mirror, the automatic adjustment device comprising:
a main controller, which comprises a microprocessor, the main controller being installed in the automobile and being connected to a signal source of a shift stick reverse position and signal sources of left and right turn signal lights of the automobile, the main controller further connected to a drive unit of a mirror panel of the sideview mirror; and
a sensor element, which is connected to the main controller, the sensor element being mounted to a back side of the mirror panel and rotatable in unison therewith, whereby the sensor element detects and transmits a parameter representing an angular position of the mirror panel to the microprocessor of the main controller with which the microprocessor makes judgment.

2. The automatic adjustment device according to claim 1, wherein when the main controller receives the signal of the shift stick reverse position, the main controller generates an output signal to make the drive unit of at least one of the sideview mirror panels to drive said one mirror panel, causing a downward rotation of said one mirror panel and wherein when the main controller identify a signal indicating disengagement from the reverse position, the main controller issues an output signal to make the drive unit driving said one mirror panel in a reverse direction, causing an upward rotation of said one mirror panel and returning said one mirror panel back to an original position before the downward rotation.

3. The automatic adjustment device according to claim 1, wherein when the automobile is to take a turn and one of the left and right turn signal lights is actuated, from which the main controller receives the signal of the turn signal light, the main controller generates an output signal to make the drive unit of the sideview mirror panel corresponding to the actuated turn signal light outputting power to cause the mirror panel to rotate forward with respect to the automobile and wherein when the main controller identify a signal indicating ending of the actuation of the turn signal light, the main controller issues an output signal to make the drive unit driving the mirror panel in a reverse direction, causing the mirror panel to rotate rearward with respect to the automobile and returning the mirror panel back to an original position before the forward rotation of the mirror panel.

4. The automatic adjustment device according to claim 3, wherein when the automobile is to take a turn and one of the left and right turn signal lights is actuated, the mirror panel of the sideview mirror corresponding to the actuated turn signal light is driven by the drive unit to rotate forward to a predetermined position and is then further driven by the drive unit to slowly rotate rearward from the predetermined position and the process of alternate forward rotation and rearward rotation is repeated, making the mirror panel to repeatedly swag forward and rearward.

5. The automatic adjustment device according to claim 1, wherein when the main controller receives signals from both left and right turn signal lights, the main controller issues no output signal to the drive units of the sideview mirror panels.

6. The automatic adjustment device according to claim 1, wherein the sensor element comprises a G-sensor and a gyro sensor or any one of them.
